(19) United States
(12) Patent Application Publication
(10) Pub. No.: US 2011/0099235 A1
(43) Pub. Date: Apr. 28, 2011

(54) COLLATION OF MULTI-USER, MULTI-FORMAT, EMAIL COMMUNICATION WITH COMMON SUBJECT TITLES

(75) Inventors: ROHIT KOUL, Jammu and Kashmir (IN); GURUDUTTA RAMANATHAIAH, Bangalore (IN)

(73) Assignee: ORACLE INTERNATIONAL CORPORATION, Redwood Shores, CA (US)

(21) Appl. No.: 12/607,031

(22) Filed: Oct. 27, 2009

(51) Int. Cl. G06F 15/16; G06F 15/173

(52) U.S. Cl. 709/206; 709/224

(57) ABSTRACT

A method includes monitoring, at a server, electronic messages transmitted across a network from any one of a group of participating users, determining if any of the electronic messages include any of a stored set of keywords, sending any electronic messages that include at least one keyword to a formatting module, extracting, at the formatting module, data relating to the keyword from the electronic message according to a previously-established rule stored in the network, and collating, at the formatting module, the data relating to the keyword into a second electronic message and transmitting the second electronic message to a supervising user. A system has a status server, the status server having a storage to store at least one group of participating users and at least one keyword associated with the group, a monitoring module to monitor electronic messages from the participating users to determine if the electronic messages contain the keyword, and a formatting module to receive electronic messages that contain the keyword, extract data related to the keyword and collate the data into a second electronic message.

### BACKGROUND

Project leads and development managers need to keep up with progress on their various projects in a straight-forward and efficient manner. Current solutions involve a lot of wasted time, both for the team members providing the status and the managers gathering and reporting the status. These solutions include a weekly status meeting or conference call, email, or an internal web page or wiki type of link.

Weekly status meetings and conference calls have some fundamental problems. Generally, no written record exists for the status updates and identified issues for future reference. One member of the meeting has to act as a scribe or recorder and record the meeting. This document then needs to be routed for review and mark up, or inconsistencies, errors or omissions may exist, making the report useless. In conference calls, team members have to wait for their turn to speak. If the project lead is having a combined conference call, there are several team members that wait around until the agenda rolls around to their issues.

Using email allows every member to submit a status message with updates and issues. This requires the manager to go through a large number of status emails every week, extract the relevant information and then collate them all into a unified status report. Another issue lies in the manner of sending the message. The users may all submit their status messages differently, such as by SMS message, email with the text in the body of the email message, or email with an attached document, such as a text file or spreadsheet.

In some instances, forcing the users to conform to one type of status report causes issues for the team members. For example, one user may work in the sales force, constantly on the move, and unable to always get to a device that has spreadsheet or word processing capabilities. This user will find it easiest to communicate via text or SMS message. This solution also results in the collation problem mentioned above, where the manager has to spend time gathering up all of the information and then putting it into one form for forwarding.

The use of internal wiki pages provides another solution. However, this may require a new wiki page every week. Generally, only one person can write to a wiki at a time. This can result in one person writing for a group of people, decreasing the accuracy, and burdening that person with the task of talking to others in the group and then writing to the page.

The concept of aggregating information has been addressed in some fashion. For example, in US Patent Application Publication No. 2005/0193345, a user interface is presented that provides messages from a plurality of messaging application on a user's device. The display is real-time and is not in a message format that allows for future handling of the message, nor is it aggregated depending upon keywords, just by the user. Further, 2005/0193345 uses collation in the sense that collating compiles a single unified view of the incoming formats, such as a single screen/view with different areas displaying different formats. There is no aggregation.

U.S. Pat. No. 7,546,352 addresses merging of email replies. However, the replies are specific to the email mode of communication and the emails are already predetermined to address a particular topic, reviewer's comments on open source software.

### BRIEF DESCRIPTION OF THE DRAWINGS

FIG. 1 shows an embodiment of an electronic messaging status system.

FIG. 2 shows a flowchart of an embodiment of a method to create a status group.

FIG. 3 shows a flowchart of a method to collate a status report.

### DETAILED DESCRIPTION OF THE EMBODIMENTS

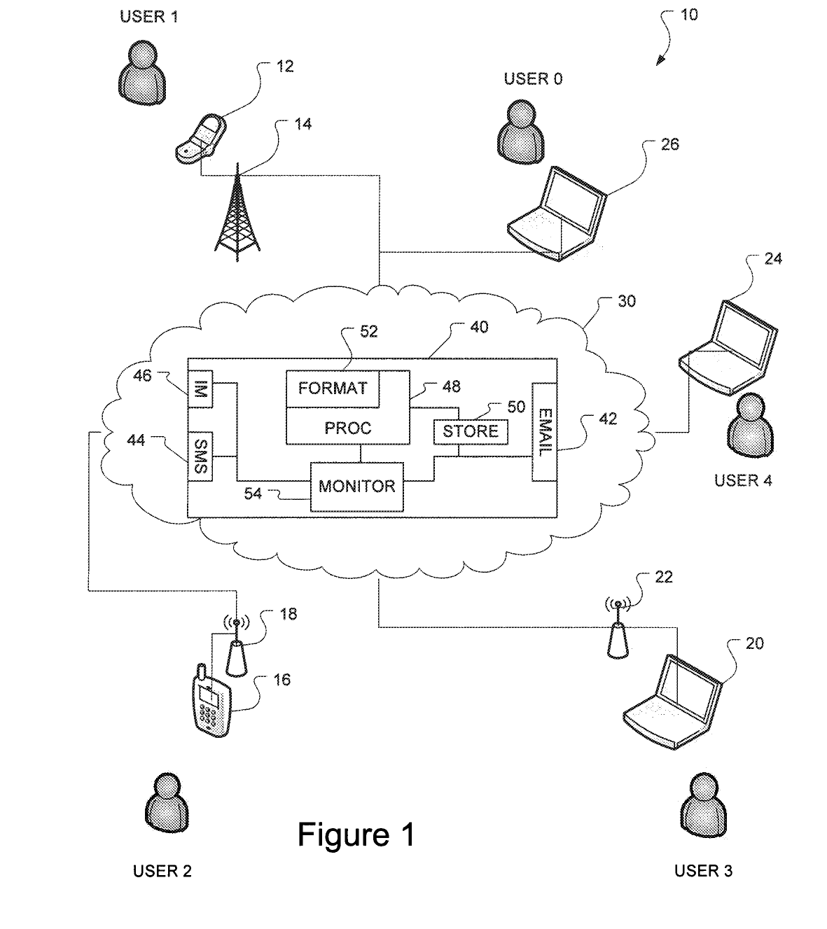

FIG. 1 shows an electronic messaging system 10 in which automated, collated status data is sent to a supervising user. It should be noted that while a particular number of users, each with a particular way to connect to the network is shown here, any number of users for any number of projects connecting in anyway to the network is contemplated by this discussion.

In the example of FIG. 1, Users 0-4 are all members of a group working on a particular project, Project X. User 0 acts as the project manager or research lead who desires to have convenient and frequent status updates provided from the participating users, such as Users 1-3. It should also be noted that only two levels of users are shown here, participating and supervising.

In more complex projects, there may be several teams, each with their own lead, reporting into an overall project lead. In that example, the status system shown here may deploy in a hierarchical or tiered manner. Each team leader would receive his or her collated status message and forward it onto the project lead, who would get the overall project collated status message. As will be discussed further, a collated status message is an electronic message that takes the relevant data from multiple messages of multiple formats from multiple participating users and collates it into one status message.

In the system of FIG. 1, for example, User 1 works in the field and may work where no Internet network connectivity exists. User 1 may submit his or her status report by an SMS (Short Message Service) or text message on his or her cell phone 12 through a cellular phone network 14. Generally, a phone number for the server within the enterprise's network, discussed below, that can receive these messages is set up.

User 2 may also work remotely, but may have a ‘smart’ phone 16 that can connect either through the Internet, typically through a Wireless Fidelity (Wi-Fi) access point such as 18, or through a cellular phone network similar to User 1. User 3 may also access the network through Wi-Fi, through computer 20 and access point 22.

User 4 and User 0 connected directly to the enterprise network 30, typically through an Ethernet connection to their respective computers 24 and 26. The network 30, as defined here, is the enterprise network that is within the enterprise that owns the electronic messaging system. The electronic messaging system will generally include electronic mail servers, such as Microsoft® Exchange® servers, and network access servers that allow users to connect to those servers. The wireless access points 18 and 22 may be part of the network, but generally the cellular phone network will not be considered part of the network.

Residing on the network is an apparatus 40. Apparatus 40 may take the form of an electronic mail server, a partition in an electronic mail server, or a partition of a more general-purpose server, as examples. No limitation exists as to the location of the apparatus 40, referred to here generally as a server, except that it resides on the network 30. It may be located on any premises within the network 30.

The apparatus 40 will generally consist of a processor 48, a memory or store 50, and at least one port that will allow it to communicate across the network 30. In this example, the apparatus 40 has at least three ports, 42, 44 and 46, each which also provide a specialized portal. Port 42 will typically be an Ethernet portal through which the server 40 connects to the network and other computers that have Ethernet connection. Port 44 in this example acts as a portal for SMS or other types of text messaging received through a cellular phone network. This portal may also have a phone number to allow users to send messages through the cellular phone network. Also included is an instant messaging portal 46 that allows reception of instant messages. Generally, instant messages will come from users connected through network connections, rather than cell phone connections, but no limitation to any connection is intended. The IM portal will generally have an IM name assigned to it, to allow it to recognize incoming messages.

The apparatus 40 may reside all in one device as shown in FIG. 1. Alternatively, some of the components may be duplicated into another device, such as a processor and a memory. This may allow for more even loading of the tasks of monitoring electronic messages and formatting them into an outgoing message.

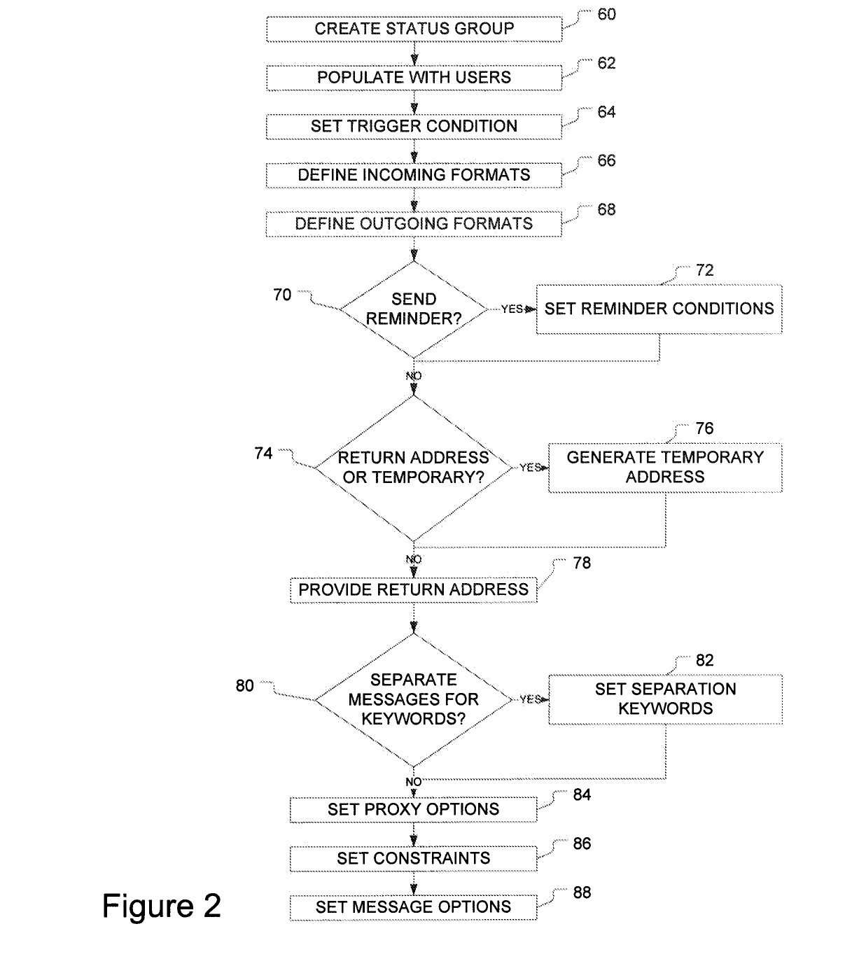

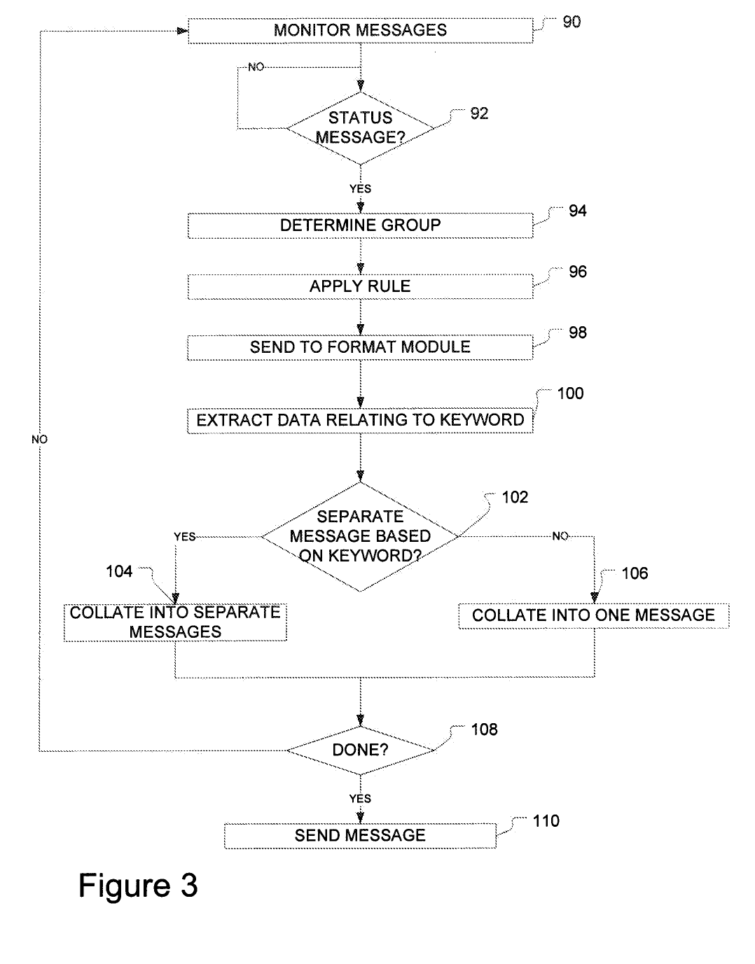

As will be discussed with regards to FIG. 2, a rule is defined by the supervising user 0 and stored somewhere in the apparatus 40. As electronic messages arrive at the apparatus 40 as electronic mail (email), instant messages (IMs) or SMS/text messages (text messages), the monitoring module 54 will identify those messages that are of interest in the status system. The method of operation for the monitor will be discussed in more detail in the discussion of FIG. 3. The monitoring module will then pass those messages to the formatting module 52 for stripping out of the relevant data. The relevant data will then be collated into at least one outgoing message that will be sent to User 0. The above consists of just a general overview; more details, examples and variations will be discussed below.

Prior to the status system being able to operate as discussed generally above, the supervising user must define the group and the relevant information used in forming the rule to be applied to the messages. FIG. 2 shows an embodiment of a method of creating a status group.

The system provides a user interface to the supervising user, User 0, to allow the supervisor to define the parameters for a rule to be applied to a particular status group. A supervising user may have multiple groups of multiple people, and some people may overlap between groups. As mentioned before, the supervising user may in turn be a participating user in another group. The concepts and examples given here apply to those situations in a similar fashion as demonstrated here.

The supervising user must first create a status group, such as Group Project X at 60. In creating the group, the supervising user will generally define keywords that will be associated with the group, such as “Project X,” “Status,” “Update,” “Issues,” and possibly other specific words relating to the nature of Project X.

The supervising user then populates the group with the various participating users and each user's contact information at 62. As discussed above, this system contemplates multiple different modes of transmitting status updates, so each user must have contact for each mode (email, text, IM) that the user will employ.

The supervising user then sets the trigger conditions at 64. The trigger conditions define the point at which the monitoring module 54 of FIG. 1 becomes active and how often. It also may define how long the monitoring module may remain active, although that may also be influenced by the constraints defined elsewhere. For example, the trigger condition may be a day of the week, a set of particular dates, a time of day (possibly expressed in GMT), every week, every month, etc. The trigger condition may also involve an event occurrence. For example, the supervising user may update an event in a workflow management system that then triggers status report monitoring for the users affected by that event.

At 66 and 68, the supervising user defines a set of possible incoming formats for incoming status messages and the desired outgoing format(s). This may include Excel® spreadsheets, Microsoft® Word® documents, portable document format (PDF), real-time feeds such as RSS, extended mark up language documents (XML), hypertext messages (HTML), text messages and IMs. This allows the formatting module to determine what text parsers or other modules it will use to strip out the relevant data from incoming messages, as well as to format the outgoing message into the correct form for transmission.

Several options may be presented to the supervising user, such as whether a reminder message should be sent at 70. Upon occurrence of the trigger condition, or just before it, the system may send the participating users a reminder that their status reports are due. If this option is selected at 70, the reminder conditions (within 3 hours of the due time, etc.) can be set at 72.

If the supervising user desires at 74, the system could define a temporary address. The temporary address may be the address from which the collated mail goes to the manager, for example ADDR1. The supervising user would then see the ADDR1 address s the ‘from’ address in the email. This may also afford the users the ability to reply to the email that would cause the email to the ADDR1 constituents, treating ADDR1 as a distribution list. The return address may be heterogeneous entities, such as return email messages, SMS messages, and IM messages. It is also possible that a reply message would cause the messages to be sent to the senders in the original format in which they chose to send the original status message.

The address may be used at 76 for receiving the status reports. This may avoid cluttering the supervising user's inbox. Alternatively, the supervising user can provide a return address, such as his or her address, for the collated status message at 78.

Options exist with regard to the collated status message as well. For example, the supervising user may want to separate periodic updates from critical issues. This option would be defined at 80. If the supervising user chooses to separate messages based upon some level of priority or the nature of the message, these options would be set at 82. Keywords for separation may include “Issues,” “Update,” “Priority,” or a series of escalating levels of priority, such as “Routine,” “Important,” and “Critical.” These keywords, as well as the other keywords to be used in the group, previously defined at 60, will be communicated to the participating users.

Another option may be to allow proxies. A proxy would be a first participating user sending a status in for a second participating user. For example, User 1 goes on vacation and leaves User 2 all of the necessary status information for the next status message. This may take the form of, “Status of User: User1,” and “Status of User: User 2,” to let the system know that the message contains status for multiple users. The supervising user decides to allow proxies or not at 84.

As mentioned above with regard to the trigger conditions, more flexibility of defining the triggering period, etc., is provided by the ability set constraints at 86. A constraint may take the form of an instruction for the monitoring module to continue to monitor for status reports. Examples of monitoring based on time include for the monitoring module to continue to monitor N hours from receiving the first message, N hours from receiving the Kth message, N hours from receiving status message from User N, absolute time (monitor for 2 hours, as an example). Alternatively, one could set up monitoring based upon users. Examples include monitoring until messages are received from Users 1-N, monitor until a message is received from User N, stop monitoring as soon as a message is received from User N, etc.

Another option involves sending the collated status message. The options include sending the collated status message to the supervising user, User 0, only; sending the message to the group; sending the message to a mailing list; etc. When the user has finished all of the various options set forth above, the system combines the options into a set of instructions for the monitoring and formatting modules, possibly in the form of a Java® or XML script.

It must be noted that the formation of the rule set out above follows a particular sequence. However, there is no limitation to a particular sequence. Indeed, the options could be presented to the user in the form of a user interface with checkboxes and fill in the blank options and the user would fill it out in whatever sequence the user desires.

Once the parameters of the rule are defined, the system can begin operating under the rule. FIG. 3 shows an embodiment of this process. Initially, the monitoring module on the server would monitor messages on the system. The system checks whether the message is a potential candidate for formatting and collation at 92. Generally, this will involve checking the subject line of the message. Typically, this will be pre-arranged by the members of the group.

For the IM/SMS channels, the checking process at 92 may be skipped. The SMS messages are coming to a specific gateway identified by a particular phone/message number of IM address. This may include a pre-defined IM template that automatically adds ‘@status’ or something similar upon sending the message.

The user may belong to multiple different groups. For example, in the case where U0 is the supervising user, U1 may belong to two different of U0's groups, G1 and G2. The subject line may require more detail than just ‘status,’ such as ‘status for ABC’ or other keywords to allow differentiation between the two groups to which the user belongs. In the case of an ambiguity, the first encountered group could be used. This may be a configuration option for the supervising user when setting up the groups.

Alternatively, the common subject line may have a pre-defined format, such as “Group 001:Status for XY Project, week ending Sep. 9, 2009.” While this format has to be predefined and used by all of the users of that group, it does have some advantages. Using this type of format reduces the chances of group ambiguities. If a user, (U2), belonging to a different group tries to send this status, it will not work. The system would only check for Group 001.

Once the group is determined, the group rule, discussed in detail with regard to FIG. 2, is accessed at 98. In applying the group rule, the formatting module receives the messages of interest and at 100 parses out the relevant text. The formatting module operates on the messages of interest to extract data relating to the keyword at 100.

Extraction of the data would more than likely involve parsing or interpreting of the text based upon the keywords defined in the group rule. This may result from parsing XML text with tags identifying the subject matter, a configuration file having keywords/tags used in a plain text interpreter, etc.

Once the data is extracted from the message, the process turns to the collation process at 102. If the supervising user designated separate messages based upon particular keywords, such as “Updates” and “Issues” the system collates the relevant data for each keyword into separate messages at 104. If the supervising user does not want any separation, the keywords and relevant text are collated into one message at 106.

Depending upon the trigger conditions and the constraints set up by the supervising user, discussed with regard to FIG. 2, the system may determine if monitoring is still active at 108. If monitoring has concluded at 108, the message(s) are sent at 110 in accordance with the group rule. If monitoring remains active, the system returns to monitoring at 90.

In this manner, a supervising user receives a collated status message from all of the participating users as one, automated, message. It saves time and effort on both ends of the process, providing the supervising user with a unified status report, and allows users to send in their status with ease and through several different modes.

Thus, although there has been described to this point a particular embodiment of a computer-controlled method and system to automatically collate a status message, it is not intended that such specific references be considered as limitations upon the scope of this invention except in-so-far as set forth in the following claims.

What is claimed is:

1. A computer-controlled method, comprising:
monitoring, at a server, electronic messages transmitted across a network from any one of a group of participating users;
determining if any of the electronic messages include any of a stored set of keywords;
sending any electronic messages that include at least one keyword to a formatting module;
extracting, at the formatting module, data relating to the keyword from the electronic message according to a previously-established rule stored in the network; and
collating, at the formatting module, the data relating to the keyword into a second electronic message and transmitting the second electronic message to a supervising user.

2. The computer-controlled method of claim 1, further comprising providing, at the server, a user interface to the supervising user to allow the supervising user to populate the group of participating users.

3. The computer-controlled method of claim 1, further comprising providing, at the server, a user interface to the supervising user to allow the supervising user to define parameters for the rule.

4. The computer-controlled method of claim 1, wherein monitoring comprising monitoring only during pre-defined trigger time period.

5. The computer-controlled method of claim 1, wherein determining comprises checking a subject line of the electronic message for at least one keyword.

6. The computer-controlled method of claim 1, wherein collating the text occurs after one of a predetermined number of electronic messages have been received or an electronic message from a particular user has been received.

7. The computer-controlled method of claim 1, wherein collating the text comprises separating text into separate electronic messages depending upon the keyword.

8. The computer-controlled method of claim 1, wherein the formatting module resides on the server.

9. The computer-controlled method of claim 1, wherein extracting text comprises:
identifying a format of the electronic message; and
using the format of the electronic message to identify the data to be extracted.

10. The computer-controlled method of claim 1, wherein collating the data into a second electronic message comprises formatting the data into a format defined by the previously-existing rule.

11. The computer-controlled method of claim 1, wherein the electronic message contains data for more than one participating user.

12. The computer-controlled method of claim 1, wherein transmitting the second electronic message comprises transmitting the second electronic message to at least one of the participating users.

13. A system, comprising:
a status server, the status server comprising:
a storage to store at least one group of participating users and at least one keyword associated with the group; and
a monitoring module to monitor electronic messages from the participating users to determine if the electronic messages contain the keyword; and
a formatting module to receive electronic messages that contain the keyword, extract data related to the keyword and collate the data into a second electronic message.

14. The system of claim 13, further comprising a short message service (SMS) portal.

15. The system of claim 13, further comprising an instant messaging portal.

16. The system of claim 13, wherein the status server further comprises a user interface to allow a supervising user to populate a group of participating users.

17. The system of claim 13, wherein the formatting module resides on the server.

18. The system of claim 13, wherein the formatting module further comprises a message queue to allow the formatting module to store messages for collation.
